(19) United States
(12) Patent Application Publication
(10) Pub. No.: US 2018/0046536 A1
(43) Pub. Date: Feb. 15, 2018

(54) Guest Enlightened Virtual Faults

(71) Applicant: Microsoft Technology Licensing, LLC, Redmond, WA (US)

(72) Inventors: Mehmet Iyigun, Kirkland, WA (US); Kevin Michael Broas, Kirkland, WA (US); Arun U. Kishan, Kirkland, WA (US); Yevgeniy M. Bak, Redmond, WA (US); John Joseph Richardson, Coupeville, WA (US)

(21) Appl. No.: 15/343,970

(22) Filed: Nov. 4, 2016

Related U.S. Application Data
(60) Provisional application No. 62/372,716, filed on Aug. 9, 2016.

(51) Int. Cl. G06F 11/07; G06F 9/455

(52) U.S. Cl. CPC G06F 11/0793; G06F 11/0712; G06F 11/0751; G06F 11/0772; G06F 11/079; G06F 9/45558; G06F 2009/45583

(57) ABSTRACT

Processing faults in a virtual computing environment. A method includes receiving a request to perform a memory access for a virtual machine. The method further includes identifying that that the memory access is unable to be performed without taking a fault. The method further includes identifying that a virtual fault can be taken to service the fault. The virtual fault is taken by servicing the fault asynchronously with respect to the virtual machine. The method further includes identifying that a virtual fault should be taken by evaluating criteria to weigh taking a virtual fault for servicing the fault asynchronously versus servicing the fault synchronously. As a result of identifying that a virtual fault should be taken, the method farther includes notifying the virtual machine that a virtual fault should be taken for the memory access. The method further includes servicing the fault asynchronously with respect to the virtual machine.

### CROSS-REFERENCE TO RELATED APPLICATIONS

This application claims the benefit of and priority to U.S. Provisional Patent Application Ser. No. 62/372716 filed on Aug. 9, 2016 and entitled “Guest Enlightened Virtual Faults,” which application is expressly incorporated herein by reference in its entirety.

### BACKGROUND

### Background and Relevant Art

When a virtual machine is executing and accesses a guest physical page that is not currently accessible a fault occurs) for the desired access type (e.g., read, write, or execute), an intercept is issued to the hypervisor to resolve the fault and resume the virtual processor when fault servicing done. The virtual processor is stalled while the fault is resolved by the hypervisor (often with the help of the host OS). This is referred to as second level paging. It may take a considerable amount of time to resolve a fault because it may involve reading data in from the disk (e.g. paging in from a pagefile). The guest virtual machine is essentially idle while the fault is being resolved.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment illustrated herein includes a computer implemented method. The method includes acts for processing faults in a virtual computing environment. The method includes receiving a request to perform a memory access for a virtual machine. The method further includes identifying that that the memory access is unable to be performed without taking a fault. The method further includes identifying that a virtual fault can be taken to service the fault. The virtual fault is taken by servicing the fault asynchronously with respect to the virtual machine. The method further includes identifying that a virtual fault should be taken by evaluating criteria to weigh taking a virtual fault for servicing the fault asynchronously versus servicing the fault synchronously. As a result of identifying that a virtual fault should be taken, the method further includes notifying the virtual machine that a virtual fault should be taken for the memory access. The method further includes servicing the fault asynchronously with respect to the virtual machine.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a host system and virtual fault enlightened virtual machine; and

FIG. 2 illustrates a computer implemented method for processing faults in a virtual computing environment

### DETAILED DESCRIPTION

Embodiments illustrated herein may allow a goes machine to run other threads on a virtual processor when a virtual page fault occurs. This can be accomplished by making a guest OS in a virtual environment aware that it took a virtual page fault. This can prevent stalling the entire physical CPU while the virtual page fault is being serviced. Further, embodiments may include functionality for determining when to take a virtual page fault allowing the guest virtual machine to run other threads using asynchronous fault servicing and when to simply allow synchronous servicing of the fault.

Previously, when a virtual machine was executing and accessed a guest physical page that is not currently accessible for the desired access type (read, write, execute), an intercept was issued to the hypervisor to resolve the fault and resume the virtual processor when it is done. Thus, the virtual processor would be stalled while the fault was resolved by the hypervisor (often with the help of the host OS). This is referred to as second level paging. It may take a considerable amount of time to resolve a fault because it may involve reading data in from the disk (e.g. paging in from the pagefile) and during that entire time, the guest virtual machine is not able to run any threads on that virtual processor.

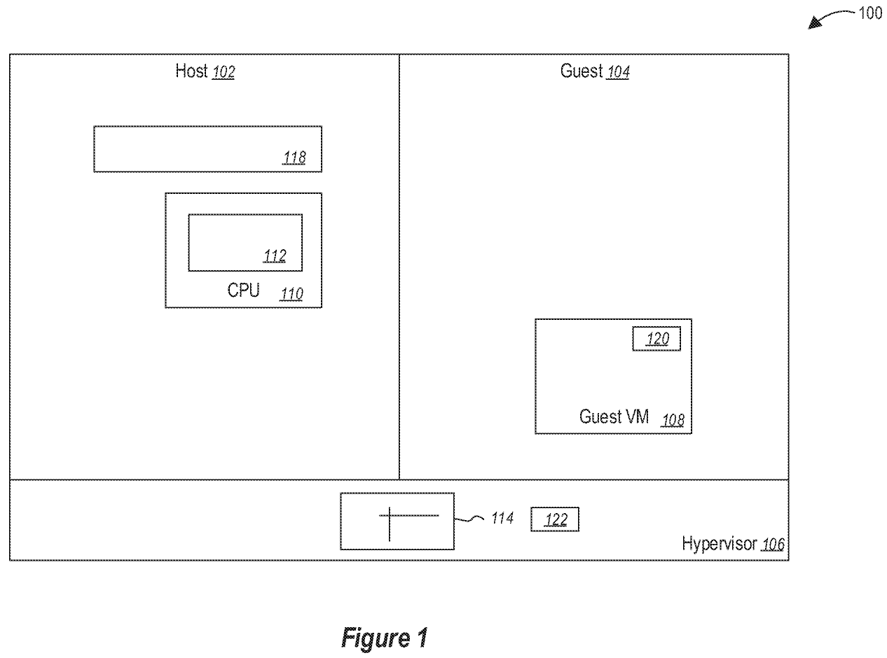

Referring now to FIG. 1, an example host machine 100 is illustrated. The host machine 100 can be used to implement virtual machines. The host machine 100 logically includes a host portion 102 and a guest portion 104, The host machine 100 further includes a hypervisor 106, which is a virtual machine manager that manages running virtual machines on the host machine 100. The hypervisor 100 may be software, firmware, hardware, or combinations of these.

Embodiments herein can include a guest virtual machine enlightenment that allows the hypervisor 106 to notify a guest virtual machine 108 running in the guest portion 104 that it has taken such an intercept (i.e., a virtual fault) and allow the guest virtual machine 108 to de-schedule the current faulting thread from the CPU 110 as it would if it took a page fault natively. If the guest virtual machine 108 is able to dc-schedule the current faulting thread from a physical CPU 110 executing instructions on the host machine 100, the hypervisor 106 can allow a virtual processor 112 to continue execution of new guest thread(s) while it is servicing the original virtual fault asynchronously. When that fault servicing completes, the hypervisor 106 notifies the guest virtual machine 108 that the original de-scheduled thread can now be re-scheduled at the guest virtual machine's convenience. This allows the guest virtual machine 108 to more fully utilize its CPU resources in the face of second level paging.

For example, when a virtual processor 112 performs a memory access that is not allowed in an address translation data structure 114, such as the Second Level Access Translation (SLAT) in Windows Server available from Microsoft Corporation of Redmond, Wash., due to page permissions or the page simply being invalid, the address translation data structure 114 generates an intercept to the hypervisor 106. At this point, the hypervisor 106 checks whether the guest virtual machine 108 supports the fault enlightenment.

If the guest virtual machine 108 supports the fault enlightenment, the hypervisor 106 checks whether the virtual fault occurred with interrupts disabled or at an elevated IRQL such that the guest virtual machine 108 could not de-schedule the thread, even if virtual faults are desired. In such cases, the virtual processor 112 is stalled as before and synchronous fault servicing is performed.

However, when a virtual fault is taken with fault enlightenment, the hypervisor 106 initiates asynchronous work to service the virtual fault (which usually involves sending the work to a host process 118) and then injects an interrupt into the faulting virtual processor 112 specifying a unique key for this virtual fault,

The unique key could be a monotonically increasing sequence number, for example. The guest virtual machine 108 processes the interrupt, which informs the guest virtual machine 108 that the currently interrupted thread (on the CPU 110 which received the interrupt) hit a virtual fault and should be de-scheduled off the CPU 110. The guest virtual machine 108 de-schedules the thread off the CPU 110 and puts it in a data structure 120, such as a global tree associated with the unique key of the virtual fault. As part of this operation, the CPU 110 becomes idle so that the guest virtual machine 108 can schedule another thread to run as might normally be performed after interrupt servicing is complete in synchronous fault servicing, except that in this case, the scheduling can be done before fault servicing is complete. I.e., asynchronous fault servicing is performed. The virtual processor 112 continues to run the guest virtual machine 108 code as usual after this scheduling is performed.

When the hypervisor 106 is done servicing the fault, it injects another interrupt into the guest virtual machine 108 with the unique fault key signifying that that virtual fault is now complete. The guest virtual machine 108 receives the interrupt and looks up the unique key in its data structure 120, which in the illustrated example is a tree of threads, currently force-de-scheduled due to pending virtual faults. It removes the thread corresponding to this fault key from the data structure 120 and makes it ready to ran on any CPU 110 the scheduler 122 chooses.

While a virtual fault is outstanding in the hypervisor 106 (or other host process), the guest virtual processor 112 may take another virtual fault and the entire process will repeat resulting in two asynchronous virtual faults being serviced by the hypervisor 106 (or other host process). In some embodiments, this can repeat N times and the hypervisor 106 where N is a policy defined limit on the number of asynchronous faults that may be taken.

In other embodiments, the hypervisor 106 may not use unique keys to identify individual virtual faults. Rather, the key can be the guest page number (GPN) that the guest virtual machine 108 faulted on. Multiple threads can become reschedulable in that case when the fault completion interrupt is received by the guest virtual machine 108.

The injected fault information may also include page protection desired when the fault was triggered to help disambiguate which threads to make schedulable again by the guest virtual machine 108. This can be done to avoid rescheduling threads prematurely as that would simply result in another virtual fault.

The hypervisor 106 may implement policy that does not immediately inject the virtual fault notification into the guest virtual machine 108 when a virtual fault occurs. The hypervisor 106 may choose to use a heuristic to determine how long the fault will take to service (or based on other factors, as described below) to decide whether it is more performant to reschedule the guest virtual processor 112 or to just stall it for a short time. In some embodiments, the hypervisor 106 could initiate servicing of the fault and wait a short, predetermined time for servicing to complete. If the fault servicing is not completed in the predetermined time, then the fault information is injected into the guest virtual machine 108 and the virtual processor 112 is resumed. In alternative or additional embodiments, the hypervisor 106 can communicate with the host to determine whether the fault would take a “long time” according to some predetermined policy to complete and then determine whether or not to inject the fault information into the guest virtual machine 108.

Thus, embodiments can determine from the hypervisor 106 and host OS whether a virtual fault can be taken or not. In some embodiments, this may be based on whether or not virtual machines include enlightenment enhancements that allow virtual faults to be indicated to the virtual machine. If the virtual machine is not able to handle or recognize virtual faults, then virtual faults cannot be taken.

In addition to determining if a virtual fault with asynchronous fault servicing can be taken, embodiments are also able to determine if a virtual fault with asynchronous servicing should be taken. For example, sometimes a virtual fault with asynchronous servicing should not be taken because there may be a decision to perform synchronous fault servicing.

Some embodiments may determine to perform asynchronous fault servicing (i.e., take a virtual fault) based on the amount of time required to process a virtual fault. In particular, if a virtual fault would take a significant amount of time (e.g., more than some predetermined amount of time) to process, then a virtual fault may be taken such that other threads or other VMs can be processed while fault servicing is occurring. The following illustrates examples of various factors that may be taken into account to determine whether asynchronous fault servicing or synchronous fault servicing should be performed.

For example, in some embodiments, embodiments may determine whether a fault is a hard fault (i.e., a disk fault that requires accessing a disk to obtain data) or a soft fault (i.e., a memory fault that can be serviced by accessing memory). Hard faults typically require more time to service and thus would be a factor pointing towards performing asynchronous fault servicing whereas soft faults would point more in favor of synchronous fault servicing. Although, in other embodiments, the level of cache that needed to be accessed to service the fault may actually point to asynchronous processing if several levels of cache need to be accessed.

Alternatively or additionally, embodiments may be evaluate the rate that faults are occurring. For example, in some embodiments, as fault rates increase, so too does weighting in favor of asynchronous fault servicing.

Alternatively or additionally, embodiments may evaluate whether a memory page needs to be zeroed or not to service the fault. Needing to zero a page may indicate a significant amount of processing that needs to be done taking a significant amount of time, pointing to a preference for asynchronous processing.

Alternatively or additionally, embodiments may evaluate whether a memory page needs to be decompressed to service a fault, Decompressing a memory page may indicate a significant amount of processing that needs to be done taking a significant amount of time, pointing to a preference for asynchronous processing.

Alternatively or additionally, embodiments may evaluate other activity on a hosting system or on other VMs. For example, embodiments may identify a situation where fault servicing could be performed quickly, but the VM is a low priority VM and other VMs (which may or may not be higher priority) are ready for processing, In such cases embodiments may identify factors that weigh more in favor of asynchronous processing, Thus, embodiments may take into account the importance of the VM and other VMs and/or whether or not the other VMs are ready for processing,

Thus, as illustrated herein, the hypervisor 106 has the ability to detect when a guest virtual machine 108 supports enlightened virtual faulting and is able to inject a notification into the guest virtual machine 108 when the guest virtual machine 108 takes a virtual fault. Alternatively or additionally, the hypervisor 106 has the ability to resume running the virtual processor 112 of the guest virtual machine 108 VM after notifying the guest virtual machine 108 via the enlightenment while initiating servicing of the original virtual fault. Alternatively or additionally, the hypervisor 106 has the ability to notify the guest virtual machine 108 when the original fault completes. Alternatively or additionally, the hypervisor 106 uniquely identifies each fault instance to the guest virtual machine 108 (e.g., via a unique key) when performing notifications described above so that the guest virtual machine 108 can efficiently re-schedule threads for which virtual fault servicing has completed. Alternatively or additionally, the hypervisor 106 (in cooperation with the host as necessary) can efficiently (e.g., heuristically) determine whether it is best to perform the enlightened fault notification or stall the virtual process for a short time depending on certain factors, such as the estimated duration of the fault servicing. Alternatively or additionally, the guest virtual machine 108 has the ability to reschedule the faulting thread when notified by the hypervisor 106 and efficiently resume that specific thread when notified of virtual fault completion, for example, using the unique fault key information provided by the hypervisor 106.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

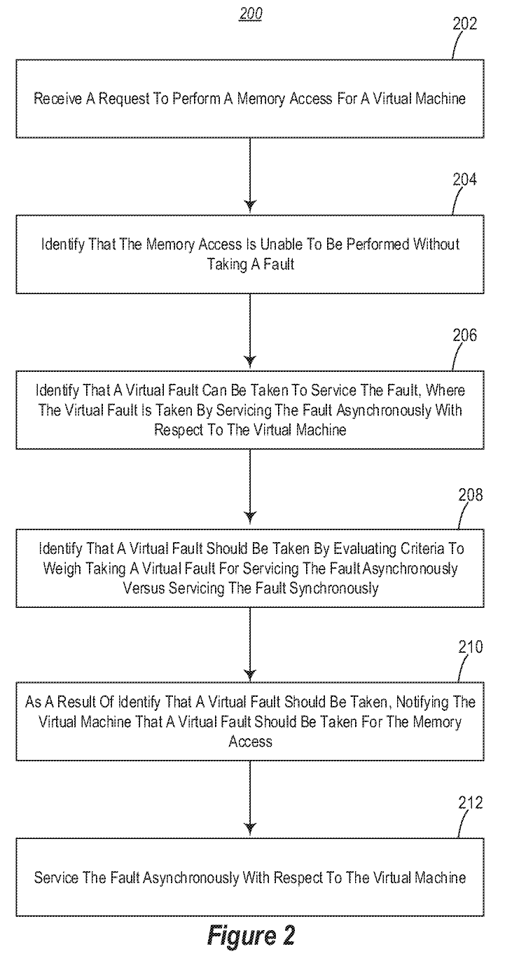

Referring now to FIG. 2, a method 200 is illustrated. The method 200 is a computer implemented method for processing faults in a virtual computing environment. The method 200 includes receiving a request to perform a memory access for a virtual machine (act 202). For example, the guest virtual machine may request the hypervisor 106 to perform sonic memory access.

The method 200 further includes identifying that that the memory access is unable to be performed without taking a fault (act 204). For example, the hypervisor 106 may consult the translation data structure 114 and identify that a fault must be taken (e.g., a disk access must be performed) to perform the memory access.

The method 200 further includes identifying that a virtual fault can be taken to service the fault, where the virtual fault is taken by servicing the fault asynchronously with respect to the virtual machines (act 206). Thus, for example, the guest virtual machine 108 may have functionality to be notified of the fault such that processing can continue asynchronously such that a CPU 110 and virtual processor 112 implementing the virtual machine 108 are not stalled while the fault is being serviced.

The method 200 further includes identifying that a virtual fault should be taken by evaluating criteria to weigh taking a virtual fault for servicing the fault asynchronously versus servicing the fault synchronously (act 208). Several examples of criteria are illustrated below.

As a result of identifying that a virtual fault should be taken, the method 200 further includes notifying the virtual machine that a virtual fault should be taken for the memory access (act 210), For example, the hypervisor 106 can notify the guest virtual machine 108 that a virtual fault will be taken.

The method 200 further includes servicing the fault asynchronously with respect to the virtual machine (act 212).

The method 200 may be practiced where evaluating criteria to weigh taking a virtual fault for servicing the fault asynchronously versus servicing the fault synchronously comprises evaluating criteria indicating how long the fault will take to service. For example, faults that take longer to service may be better serviced asynchronously so as to not unnecessarily tie up system resources.

The method 200 may be practiced where evaluating criteria to weigh taking a virtual fault for servicing the fault asynchronously versus servicing the fault synchronously comprises evaluating criteria indicating whether the fault is a hard fault or a soft fault. In particular, hard faults may take more time to service than soft faults and thus it may be better to service the fault asynchronously.

The method 200 may be practiced where evaluating criteria to weigh taking a virtual fault for servicing the fault asynchronously versus servicing the fault synchronously comprises evaluating criteria identifying whether or not a memory page needs to be zeroed to service the fault. In particular, zeroing a page may represent a significant amount of work that needs to be performed and may point to servicing the fault asynchronously.

The method 200 may be practiced where evaluating criteria to weight taking a virtual fault for servicing the fault asynchronously versus servicing the fault synchronously comprises evaluating criteria identifying whether or not a memory page needs to be decompressed to service the fault. In particular, if a memory page needs to be decompressed, this may represent a significant amount of work that needs to be performed and may point to servicing the fault asynchronously.

The method 200 may be practiced where evaluating criteria to weigh taking a virtual fault for servicing the fault asynchronously versus servicing the fault synchronously comprises evaluating criteria identifying priority of one or more virtual machines. In particular, if high priority virtual machines are waiting to have work performed, this may point in favor of asynchronous servicing to allow those virtual machines to be able to schedule work. However, if the currently faulting virtual machine is higher priority than other machines, this may point to synchronous processing to allow the faulting machine to maintain control over or to maintain scheduling of resources.

The method 200 may be practiced where evaluating criteria to weigh taking a virtual fault for servicing the fault asynchronously versus servicing the fault synchronously comprises evaluating criteria identifying evaluating priority of one or more threads scheduled to be run by virtual machines. Thus, similar to priority of machines, priority of individual threads may inform whether or not servicing should be performed synchronously or asynchronously. If the faulting thread has higher priority than other threads, then the evaluation may indicate a preference for servicing synchronously, while if other threads have a higher priority than the faulting thread, the evaluation may indicate a preference for servicing asynchronously to allow resources (e.g., CPUs) to be freed up to handle these threads.

The method 200 may be practiced where evaluating criteria to weigh taking a virtual fault for servicing the fault asynchronously versus servicing the fault synchronously comprises evaluating criteria identifying a rate at which faults are occurring. Normally a query occurs to see if the operating system expects the fault to be resolved quickly (due to a local cache), or after a longer period of time (due to needing to obtain data from a disk or from a remote location). In all cases that the fault may be resolved quickly the reschedule fault is not injected (i.e., a guest not notified). In cases in which the fault may take some time, as much parallelism as possible is highly desirable and is accomplished by injecting the reschedule fault and servicing the I/O asynchronously. But this does consume real system resources, so a throttle may be implemented to limit these outstanding requests to a maximum number. This way system resources may be bounded by a guest that generates a lot of faults, and is re-schedulable

The method 200 may be practiced where criteria to weigh taking a virtual fault for servicing the fault asynchronously versus servicing the fault synchronously comprises evaluating criteria identifying whether there are other runnable threads at the virtual machine. For example, if a faulting virtual machine does not have other threads, then there may be a preference for synchronous servicing, but if other runnable threads are available, then there might a preference identified for asynchronous servicing.

The method 200 may be practiced where evaluating criteria to weigh taking a virtual fault for servicing the fault asynchronously versus servicing the fault synchronously comprises evaluating criteria identifying a cost for synchronous fault servicing versus a cost for asynchronous fault servicing.

Not that the various factors may be weighted together such that weighing several factors may be performed to determine whether to perform synchronous servicing or asynchronous servicing.

Further, the methods may be practiced by a computer system including one or more processors and computer-readable media such as computer memory. In particular, the computer memory may store computer-executable instructions that when executed by one or more processors cause various functions to be performed, such as the acts recited in the embodiments.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer-readable storage media and transmission computer-readable media.

Physical computer-readable storage media includes RAM, ROM, EEPROM, CD-ROM or other optical disk storage (such as CDs, DVDs, etc), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable.

instructions or data structures received over a network or data link can be buffered in RAM within a network interface module (e.g., a “NIC”), and then eventually or transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system comprising:
one or more processors; and
one or more computer-readable media having stored thereon instructions that are executable by the one or more processors to configure the computer system to process faults in a virtual computing environment, including instructions that are executable to configure the system to perform at least the following:
receive a request to perform a memory access for a virtual machine;
identify that that the memory access is unable to be performed without taking a fault;
identify that a virtual fault can be taken to service the fault, where the virtual fault is taken by servicing the fault asynchronously with respect to the virtual machine;
identify that a virtual fault should be taken by evaluating criteria to weigh taking a virtual fault for servicing the fault asynchronously versus servicing the fault synchronously;
as a result of identify that a virtual fault should be taken, notifying the virtual machine that a virtual fault should be taken for the memory access; and
service the fault asynchronously with respect to the virtual machine.

2. The system of claim 1, wherein evaluating criteria to weigh taking a virtual fault for servicing the fault asynchronously versus servicing the fault synchronously comprises evaluating criteria indicating how long the fault will take to service.

3. The system of claim 1, wherein evaluating criteria to weigh taking a virtual fault for servicing the fault asynchronously versus servicing the fault synchronously comprises evaluating criteria indicating whether the fault is a hard fault or a soft fault.

4. The system of claim 1, wherein evaluating criteria to weigh taking virtual fault for servicing the fault asynchronously versus servicing the fault synchronously comprises evaluating criteria identifying whether or not a memory page needs to be zeroed to service the fault.

5. The system of claim 1, wherein evaluating criteria to weigh taking a virtual fault for servicing the fault asynchronously versus servicing the fault synchronously comprises evaluating criteria identifying whether or not a memory page needs to be decompressed to service the fault.

6. The system of claim 1, wherein evaluating criteria to weigh taking a a fault for servicing the fault asynchronously versus servicing the fault synchronously comprises evaluating criteria identifying priority of one or more virtual machines.

7. The system of claim 1, wherein evaluating criteria to weigh taking a virtual fault for servicing the fault asynchronously versus servicing the fault synchronously comprises evaluating criteria identifying evaluating priority of one or more threads scheduled to be run by virtual machines.

8. The system of claim 1, wherein evaluating criteria to weigh taking a virtual fault for servicing the fault asynchronously versus servicing the fault synchronously comprises evaluating criteria identifying a rate at which faults are occurring.

9. The system of claim 1, wherein evaluating criteria to weigh taking a virtual fault for servicing the fault asynchronously versus servicing the fault synchronously comprises evaluating criteria identifying whether there are other runnable threads at the virtual machine.

10. The system of claim 1, wherein evaluating criteria to weigh taking a virtual fault for servicing the fault asynchronously versus servicing the fault synchronously comprises evaluating criteria identifying a cost for synchronous fault servicing versus a cost for asynchronous fault servicing.

11. A computer implemented method for processing faults in a virtual computing environment, the method comprising:
receiving a request to perform a memory access for a virtual machine;
identifying that that the memory access is unable to be performed without taking a fault;
identifying that a virtual fault can be taken to service the fault,-here the virtual fault is taken by servicing the fault asynchronously with respect to the virtual machine;
identifying that a virtual fault should be taken by evaluating criteria to weigh taking a virtual fault for servicing the fault asynchronously versus servicing the fault synchronously;
as a result of identifying that a virtual fault should be taken, notifying the virtual machine that a virtual fault should be taken for the memory access; and
servicing the fault asynchronously with respect to the virtual machine.

12. The method of claim 11, wherein evaluating criteria to weigh taking a virtual fault for servicing the fault asynchronously versus servicing the fault synchronously comprises evaluating criteria indicating how long the fault will take to service.

13. The method of claim 11, wherein evaluating criteria to weigh taking a virtual fault for servicing the fault asynchronously versus servicing the fault synchronously comprises evaluating criteria indicating whether the fault is a hard fault or a soft fault.

14. The method of claim 11, wherein evaluating criteria to weigh taking a virtual fault for servicing the fault asynchronously versus servicing the fault synchronously comprises evaluating criteria identifying whether or not a memory page needs to be zeroed to service the fault.

15. The method of claim 11, wherein evaluating criteria to weigh taking a virtual fault for servicing the fault asynchronously versus servicing the fault synchronously comprises evaluating criteria identifying whether or not a memory page needs to be decompressed to service the fault.

16. The method of claim 11, wherein evaluating criteria to weigh taking a virtual fault for servicing the fault asynchronously versus servicing the fault synchronously comprises evaluating criteria identifying priority of one or more virtual machines.

17. The method of claim 11, wherein evaluating criteria to weigh taking a virtual fault for servicing the fault asynchronously versus servicing the fault synchronously comprises evaluating criteria identifying evaluating priority of one or more threads scheduled to be run by virtual machines.

18. The method of claim 11, wherein evaluating criteria to weigh taking a a fault for servicing the fault asynchronously versus servicing the fault synchronously comprises evaluating criteria identifying a rate at which faults are occurring.

19. The method of claim 11, wherein evaluating criteria to weigh taking a virtual fault for servicing the fault asynchronously versus servicing the fault synchronously comprises evaluating criteria identifying whether there are other runnable threads at the virtual machine.

20. A host computer system comprising:
a host portion, the host portion comprising one or more physical processors for hosting virtual processors for virtual machines;
a hypervisor coupled to the host portion, wherein the hypervisor manages running virtual machines on the host computer system;
one or more virtual machines, wherein at least one of the one or more virtual machines comprises a guest virtual machine enlightenment that allows the hypervisor to notify a guest virtual machine that it has taken such an intercept to allow the guest virtual machine to de-schedule a current faulting thread from a physical processor; and
wherein the hypervisor is configured to determine if a virtual fault should be taken by evaluating criteria to weigh taking a virtual fault for servicing the fault asynchronously versus servicing the fault synchronously.
